(19) United States
(12) Patent Application Publication
(10) Pub. No.: US 2026/0241859 A1
(43) Pub. Date: Aug. 20, 2026

(54) Method and Apparatus for Controlling an Illumination of a Vehicle Component in an Interior of a Vehicle

(71) Applicant: Bayerische Motoren Werke Aktiengesellschaft, Muenchen (DE)

(72) Inventors: Thomas Ewender, Bad Aibling (DE); Torsten Herzog, Muenchen (DE); Andreas Menath, Muenchen (DE)

(21) Appl. No.: 19/162,393

(22) PCT Filed: Jan. 24, 2024
(86) PCT No.: PCT/EP2024/051596

§ 371 Date: Sep. 4, 2025

(30) Foreign Application Priority Data
Mar. 13, 2023 (DE) 10 2023 106 107.0

(51) Int. Cl. B60Q 3/80; B60Q 3/233; G06T 7/70; G06V 20/59

(52) U.S. Cl. CPC B60Q 3/80; B60Q 3/233; G06T 7/70; G06V 20/593; G06T 2207/10048; G06T 2207/30268

(57) ABSTRACT

A method for controlling an illumination of a vehicle component in an interior of a vehicle includes a step of recognizing a configuration of the vehicle component by way of an interior camera of the vehicle. The method also includes controlling the illumination of the vehicle component depending on the recognized configuration of the vehicle component.

The present application is the U.S. national phase of PCT Application PCT/EP2024/051596 filed on Jan. 24, 2024, which claims priority of German patent application No. 10 2023 106 107.0 filed on Mar. 13, 2023, the entire contents of which are incorporated herein by reference.

### TECHNICAL FIELD

The disclosure relates to the field of vehicles, and more specifically to controlling an illumination of a vehicle component in an interior of a vehicle.

### BACKGROUND

A light control depending on a switching state of a microswitch of a vehicle component is known from the prior art. Hardware costs for installing the microswitch and a cable harness to the microswitch arise due to the use of a microswitch for the light control in a vehicle component.

There is a need, therefore, for a more efficient control of an illumination of a vehicle component in an interior of a vehicle. In particular, there is a need to efficiently simplify a control of an illumination of a vehicle component in the interior of the vehicle.

### SUMMARY

The above-described needs, as well as others, are addressed by one or more embodiments described and claimed herein.

A first aspect of the disclosure is a method for controlling an illumination of a vehicle component in an interior of a vehicle. The method can be a computer-implemented method and/or a controller-implemented method. The vehicle component can be an armrest, for example a center armrest of a first row of seats or a second row of seats of a vehicle. The illumination can comprise an ambient illumination and/or a functional illumination of the vehicle component.

The method comprises recognizing a configuration of the vehicle component by way of an interior camera of the vehicle, and controlling the illumination of the vehicle component depending on the recognized configuration of the vehicle component. The interior camera can comprise a single interior camera or an interior camera system having multiple interior cameras. An interior camera of the vehicle can capture light in the optical and/or infrared spectrum. Capturing light in the infrared spectrum has the additional advantage that the image capture unit can capture the interior of the vehicle even in poor light conditions, for example at night. The interior camera can be understood as stereoscopic camera or a time-of-flight camera, which operates on a three-dimensional point cloud. For example, an interior camera for capturing light in the infrared spectrum can include an active illumination. The configuration of the vehicle components can comprise a state and/or a position of the vehicle component.

The control of the illumination of the vehicle component can advantageously be made more efficient by the use of an interior camera already present in the vehicle to recognize the configuration of the vehicle component. The control of the illumination can be efficiently simplified by reduction of hardware components. At the same time, the control of the illumination can be implemented more flexibly by the use of the interior camera.

According to some embodiments, the configuration of the vehicle component can comprise a starting position, an end position, and/or one or more intermediate positions of the vehicle component. Various positions of the vehicle components can be recognized more efficiently in this way.

According to some embodiments, the configuration of the vehicle component can comprise an extended state, an open state, a retracted state, and/or a closed state of the vehicle component. Various states of the vehicle component can be efficiently recognized in this way.

According to at least one embodiment, the vehicle component can be an armrest, preferably a center armrest, of a first row of seats and/or a second row of seats of the vehicle. The method can efficiently recognize a position and/or a state of an armrest of the vehicle in this way.

According to some embodiments, the recognition of the configuration of the vehicle component by the interior camera of the vehicle can comprise recognizing an illumination of the vehicle component by the interior camera of the vehicle, wherein the illumination of the vehicle component is preferably recognized in the visible spectrum and/or in the infrared spectrum by the interior camera. The illumination of the vehicle component can be efficiently recognized in this way.

In some implementations, the illumination of the vehicle component can be controlled depending on the recognized configuration comprises a position change into a predetermined starting position, a predetermined end position, and/or one or more predetermined intermediate positions of the vehicle component, and/or the illumination of the vehicle component can be controlled depending on the recognized configuration of the vehicle components, if the configuration comprises an extended state, an open state, a retracted state, and/or a closed state of the vehicle component and/or a state change into an extended state, an open state, a retracted state, and/or a closed state of the vehicle component.

According to some embodiments, the control of the illumination can comprise switching on the illumination, switching off the illumination, and/or providing a preferably chronologically varying light pattern of the illumination of the vehicle component, and/or the illumination can comprise an ambient illumination and/or a functional illumination of the vehicle component.

According to some implementations, the recognition of the configuration of the vehicle component by the interior camera of the vehicle can comprise recognizing an extended state of the vehicle component by the interior camera of the vehicle if a preferably chronologically varying pattern of the illumination of the vehicle component is recognized by the interior camera of the vehicle, and/or can comprise recognizing a retracted state of the vehicle component by the interior camera of the vehicle if a preferably chronologically varying pattern of the illumination of the vehicle component is not recognized by the interior camera of the vehicle. For example, a light source of the illumination can permanently emit a chronologically varying pattern in an infrared spectrum. In an extended state, the same light source can additionally emit light in the visible range or in the optical spectrum. In this way, an extended and a retracted state can be recognized more reliably. In addition, an extended and a retracted state can be recognized more reliably by the emission of the chronologically varying pattern in the infrared spectrum of the light without the user of the vehicle being able to perceive the emission of the light.

According to some embodiments, the recognition of the configuration of the vehicle component by the interior camera of the vehicle can comprise recognizing an extended state, an open state, a retracted state, and/or a closed state of the vehicle component by the interior camera of the vehicle and one or more infrared light-reflecting decorative elements of the vehicle component, wherein an infrared light-reflecting decorative element is preferably an infrared light-reflecting coating or an infrared light-reflecting sticker. In this way, an extended state and a retracted state can be recognized more reliably at night.

According to at least one implementation, the method can furthermore comprise recognizing a seat occupancy of the first and/or the second row of seats of the vehicle by the interior camera of the vehicle, and controlling the illumination of the vehicle component depending on the recognized configuration of the vehicle component and the recognized seat occupancy of the first and/or second row of seats of the vehicle. The illumination can be controlled more precisely in this way.

A further aspect is a computer-readable medium for controlling an illumination of a vehicle component in an interior of a vehicle, wherein the computer-readable medium comprises instructions which, when they are executed on a computer and/or a controller, carry out the above-described method.

A further aspect is a system for controlling an illumination of a vehicle component in an interior of a vehicle, wherein the system is designed to carry out the above-described method.

A further aspect is a vehicle comprising the above-described system for controlling an illumination of a vehicle component in an interior of a vehicle.

The above-describe features and advantages, as well as others, will become more readily apparent to those of ordinary skill in the art by reference to the following detailed description and accompanying drawings.

### BRIEF DESCRIPTION OF THE DRAWINGS

FIG. 1 shows an exemplary method for controlling an illumination of a vehicle component in an interior of a vehicle,

FIG. 2 shows an exemplary vehicle having an extended center armrest, and

FIG. 3 shows an exemplary vehicle having a retracted center armrest.

### DETAILED DESCRIPTION

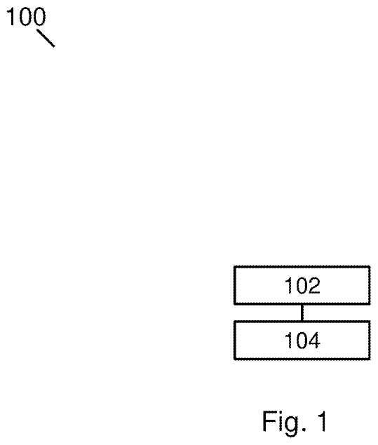

In detail, FIG. 1 shows an exemplary method 100 for controlling an illumination of a vehicle component in an interior of a vehicle.

The method 100 can recognize 102 a configuration of the vehicle component by way of an interior camera of the vehicle. For example, the interior camera can recognize whether a vehicle component center armrest on a first row of seats of the vehicle and/or a second row of seats of the vehicle is extended or retracted. In addition, the interior camera can recognize a seat occupancy of the vehicle on the first row of seats and/or the second row of seats.

The method 100 can control 102 the illumination of the vehicle component depending on the recognized configuration of the vehicle component. Additionally or alternatively, the method can control the illumination of the vehicle component depending on the recognized seat occupancy. For example, the method 100 can switch on the illumination of the vehicle component center armrest in an extended state of the center armrest. For example, the method 100 can switch off the illumination of the vehicle component center armrest in a retracted state of the center armrest. Annoying light emissions from gaps of the center armrest in the retracted state can be avoided by switching off the illumination. For example, the recognized seat occupancy can indicate that the first row of seats or the second row of seats of the vehicle is empty. A control of the illumination can be omitted with an empty row of seats and a recognized change of the configuration of the center armrest, for example an extension, a retraction, or another position change of the center armrest.

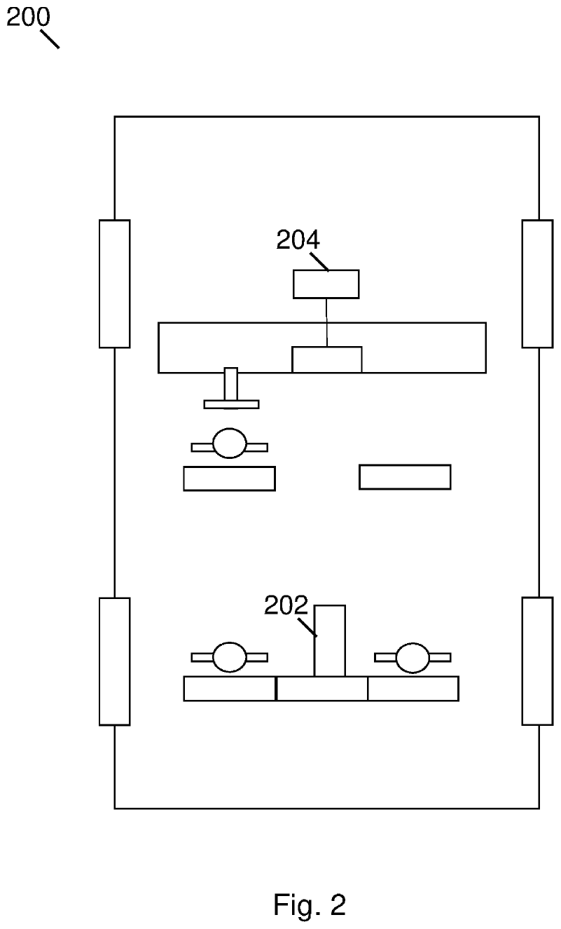

In detail, FIG. 2 shows an exemplary vehicle 200 having an extended center armrest 202. An interior camera 204 can recognize the extended center armrest 202 and control the illumination of the vehicle component in accordance with the configuration of the center armrest.

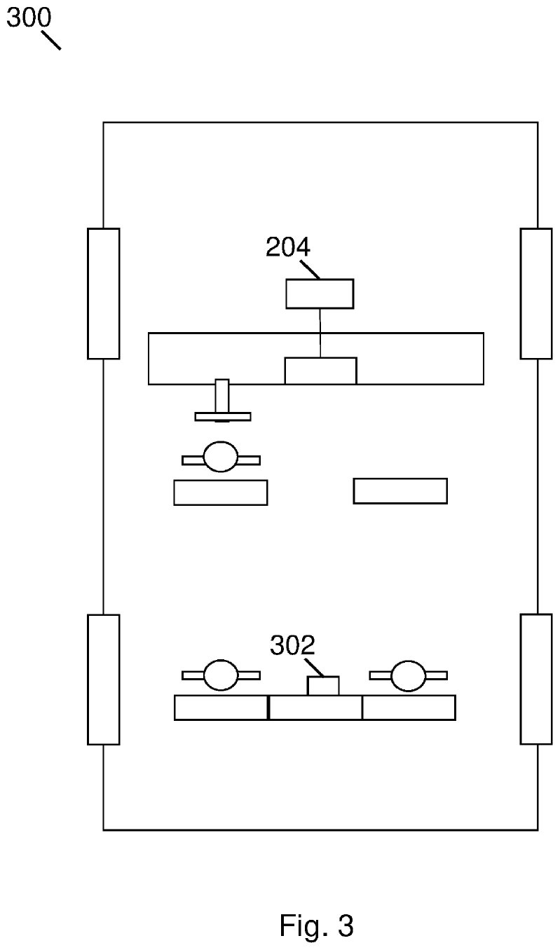

In detail, FIG. 3 shows an exemplary vehicle 300 having a retracted center armrest 302. An interior camera 204 can recognize the retracted center armrest 302 and control the illumination of the vehicle component in accordance with the configuration of the center armrest.

The control of the illumination of the vehicle components can advantageously be simplified. The vehicle can dispense with electromechanical components in order to efficiently control the illumination of a vehicle component.

### LIST OF REFERENCE SIGNS

100 method
102 recognizing a configuration
104 controlling an illumination
200 vehicle
202 extended center armrest
204 interior camera
300 vehicle
302 retracted center armrest

1.-13. (canceled)

14. A method for controlling an illumination of a vehicle component in an interior of a vehicle, the method comprising:
recognizing a configuration of the vehicle component by way of an interior camera of the vehicle; and
controlling the illumination of the vehicle component depending on the recognized configuration of the vehicle component.

15. The method according to claim 14, wherein the configuration of the vehicle component comprises at least one of a starting position, an end position, or an intermediate position of the vehicle component.

16. The method according to claim 15, wherein recognizing the configuration of vehicle component includes selecting the configuration from a starting position, an end position, or an intermediate position of the vehicle component.

17. The method according to claim 14, wherein the configuration of the vehicle component comprises at least one of an extended state, an open state, a retracted state, or a closed state of the vehicle component.

18. The method according to claim 17, wherein recognizing the configuration of vehicle component includes selecting the configuration from a starting position, an end position, or one or more intermediate positions of the vehicle component.

19. The method according to claim 14, wherein the vehicle component is an armrest of the vehicle.

20. The method according to claim 14, wherein recognizing the configuration of the vehicle component by the interior camera of the vehicle comprises:
recognizing an illumination of the vehicle component by the interior camera of the vehicle, wherein the illumination of the vehicle component is recognized in a visible spectrum or in an infrared spectrum by the interior camera.

21. The method according to claim 20 wherein recognizing the configuration of the vehicle component by the interior camera of the vehicle comprises:
recognizing an illumination of the vehicle component by the interior camera of the vehicle, wherein the illumination of the vehicle component is recognized in the visible spectrum and in the infrared spectrum by the interior camera.

22. The method according to claim 14, wherein recognizing the configuration of the vehicle component by the interior camera of the vehicle comprises:
recognizing an illumination of the vehicle component by the interior camera of the vehicle.

23. The method according to claim 22, wherein recognizing the configuration of the vehicle component by the interior camera of the vehicle comprises:
recognizing an extended state of the vehicle component by the interior camera of the vehicle if a chronologically varying pattern of the illumination of the vehicle component is recognized by the interior camera of the vehicle.

24. The method according to claim 22, wherein recognizing the configuration of the vehicle component by the interior camera of the vehicle comprises:
recognizing a retracted state of the vehicle component by the interior camera of the vehicle if a chronologically varying pattern of the illumination of the vehicle component is not recognized by the interior camera of the vehicle.

25. The method according to claim 14, wherein controlling the illumination of the vehicle component further comprises controlling the illumination of the vehicle component depending on the recognized configuration of the vehicle components if the configuration comprises a position change into a predetermined starting position, a predetermined end position, or one or more predetermined intermediate positions of the vehicle component.

26. The method according to claim 14, wherein controlling the illumination of the vehicle component further comprises controlling the illumination of the vehicle component depending on the recognized configuration of the vehicle components if the configuration comprises an extended state, an open state, a retracted state, or a closed state of the vehicle component.

27. The method according to claim 14, wherein controlling the illumination of the vehicle component further comprises controlling the illumination of the vehicle component depending on the recognized configuration of the vehicle components if the configuration comprises a state change into an extended state, an open state, a retracted state, or a closed state of the vehicle component.

28. The method according to claim 14, wherein controlling the illumination of the vehicle component comprises switching on the illumination, switching off the illumination, providing a chronologically varying light pattern of the illumination of the vehicle component.

29. The method according to claim 14, wherein recognizing the configuration of the vehicle component by the interior camera of the vehicle comprises:
recognizing an extended state, an open state, a retracted state, or a closed state of the vehicle component by the interior camera of the vehicle and one or more infrared light-reflecting decorative elements of the vehicle component; and
wherein an infrared light-reflecting decorative element is an infrared light-reflecting coating or an infrared light-reflecting sticker.

30. The method according to claim 14, further comprising:
recognizing a seat occupancy of at least a portion of the vehicle by the interior camera of the vehicle; and
controlling the illumination of the vehicle component depending on the recognized configuration of the vehicle component and the recognized seat occupancy, wherein the illumination of the vehicle components is only controlled depending on the recognized configuration if the recognized seat occupancy indicates that at least one person is seated on a seat of a row of seats associated with the vehicle component.

31. A non-transitory computer-readable medium having instructions which, when executed on a computer or a controller, carry out the method according to claim 14.

32. A system for controlling an illumination of a vehicle component in an interior of a vehicle, wherein the system is configured to carry out the method according to claim 14.

33. A vehicle comprising the system for controlling an illumination of a vehicle component in an interior of a vehicle according to claim 32.
